(19) United States
(12) Patent Application Publication
(10) Pub. No.: US 2012/0043300 A1
(43) Pub. Date: Feb. 23, 2012

(54) NanoNeedles Pulling System

(75) Inventor: Mehdi Yazdanpanah, Louisville, KY (US)

(73) Assignee: NAUGANEEDLES LLC, Louisville, KY (US)

(21) Appl. No.: 13/215,220

(22) Filed: Aug. 22, 2011

Related U.S. Application Data
(60) Provisional application No. 61/375,840, filed on Aug. 22, 2010.

(51) Int. Cl. B05D 5/00; B05D 1/00; B05D 3/10; B05C 13/00

(52) U.S. Cl. 216/83; 118/500; 427/256; 427/171

(57) ABSTRACT

The present invention provides a description for an instrument for creating arrays of metal nanostructures allows on various substrates at the wafer scale. Embodiment methods permit for the formation of individual and arrays of metal alloys of nanostructures by bringing an array of liquid metal droplets droplet in contact with an array of metal patterns by using high precision manipulation mechanism. Top view and side view optical lenses are used to observe the manipulation process and also allow for aligning the metal droplets with film of solid metal patterns. As one example, this instrument is capable of pattering high aspect ratio nanostructures such as silver-gallium (Ag₂Ga) nanowires onto prefabricated microstructures. This invention also describes a method for forming arrays of liquid metal droplets on the tip of micro structures by bringing a flexible membrane containing a liquid metal film, in contact with a pattern of microstructures.

This application claims the benefits of the provisional patent application No. 61,375,840 filed on Aug. 22, 2010.

### STATEMENT OF GOVERNMENT INTEREST

This invention was made with Government support under Grant #IIP-0944435 awarded by National Science Foundation, Grant #IIP1058576 awarded by National Science Foundation, Grant #KSTC184-512-10-082 awarded by Kentucky Science Technology Corporation, and Grant #KSTC184-512-10-107 awarded by Kentucky Science Technology Corporation. The government has certain rights in the invention.

### BACKGROUND OF THE INVENTION

Self-assembly of metallic nanostructures through the evolution of material systems toward states of thermodynamic equilibrium has been known. Creation of numerous different structures has been demonstrated by self-assembly process and is as a result of the complex physics of metal systems. Transformation between states, or phases, of matter is a function of various state variables such as temperature, pressure or composition. A change in a thermodynamic variable of an alloy system causes the system to evolve toward a new state of equilibrium, and a new state of the material.

Self-assembly methods offer less laborious and simpler fabrication approaches for materials, structures, and devices than traditional fabrication methods. With the continually decreasing feature sizes in the field of nanostructure fabrication, and the cost of traditional fabrication methods being considerable, the application of self-assembly methods is predicted to stay appealing.

Developing processes that exploit adequately controllable self-assembly methods, that also demonstrate precision, and repeatability has great potential to reduce manufacturing costs of current conventional fabrication processes. These methods can potentially be used in the fabrication of integrated devices such as micro electro mechanical systems (MEMS), BioMEMS, Microflips, and Lab-on-a-chip devices.

One prerequisite to success in the field, is the ability to securely attach nanowires at desired locations. General approaches used are as follows. One method is using mechanical or fluidics means to transport a nanstructure to a location proximate to the target and applies an electric field or electron beam to attach the object. A second class of methods is to grow nanowires on chemically patterned surfaces. Although nanowires can be grown selectively from catalyst nanoparticles by plasma enhanced chemical vapor deposition, due to the small size of the particles, the required positioning of the nanoparticles at selected locations can be quite difficult. Also, high temperatures in the PECVD and other chemical vapor deposition (CVD) methods can damage the substrate material. However, the goal in all of these approaches has been to attach one end of the nanostructures to only one point of another material, and nanostructures were never seen as means for electrical connections between two or more conductors.

In the past two decades several nano nanomaterial (e.g. nanowires, nanotubes) have been discovered and their very unique electrical and mechanical properties have been demonstrated using state-of-the-art E-Beam nanolithography approach. However, the key limitations of E-Beam lithography are (1) low throughput, (i.e., the very long processing time), (2) high complexity of the process, and (3) being a serial process. Therefore, using E-Beam lithography, it would be very difficult to fabricate inexpensive nanostructure based devices integrated into microelectronic circuits.

### SUMMARY OF THE INVENTION

In one embodiment of the present inventions, a nanoneedles pulling system (NPS) instrument is used for growing arrays of nanoneedles on predetermined microstructures in a wafer scale. In this embodiment, by bringing a film of gallium or array of gallium droplet that are in a 2 to 12 inches wafer, in contact with an array of silver coated microstructures that are in a 2 to 12 inches of wafer, the instrument is capable of growing aligned arrays of silver-gallium (Ag₂Ga) nanowires, on the micro pattern in a device.

In one embodiment, the instrument is capable of: (1) aligning two wafers with sub micrometer resolution; (2) optically viewing the gap between two wafers as they approaches to each other (3) aligning the two wafers in lateral direction; (4) tilting the lower wafer with respect the upper wafer to become parallel with each other; (5) rotating a side view camera around the wafers to view the gap between the two wafers in all different directions.

In one embodiment the elements and steps of the novel NPS instrument are: (1) a high resolution, three axis, motorized micro-manipulator. This highly accurate stage has the ability to move an object in the X, Y, and Z axes with a sub-micron resolution. This stage moves the lower wafer in relation to the upper wafer to provided X and Y alignment, as well as along the Z axis to dip the silver coated surface into the gallium droplet or film to create an array of nanoneedles; (2) a small rotation and tilt stage that sits on the motorized stage; (3) a disk shape wafer holder that hold a wafer with vacuum; (4) a ring shape stage that can hold a flexible membrane; (5) a flexible membrane that is at the top of a chamber that can hold higher pressure. (6) a small pump that is connected to the chamber that can pressurize the chamber and make the membrane to be stretched and inflated.

In another embodiment, the present invention teaches a method for uniformly forming liquid metal droplets using flexible membranes. Flexible membranes holding liquid metal droplets are stretched so that the droplet smoothly covers the whole surface area of the tip of the micro pillar. Then the surface area containing liquid metal is used to transfer liquid metal patterns.

### BRIEF DESCRIPTION OF THE DRAWINGS

FIG. 1 shows the growing process of nanoneedles arrays by Nanoneedles Pulling Station (NPS) instrument.

FIG. 2 shows the novel apparatus of nanoneedles pulling station (NPS) for pattering Ag₂Ga nanowires arrays by bringing in contact a wafer that is coated with a thin silver film in contact with array or film of Gallium.

FIG. 3 shows the novel apparatus of the lower assembly of the NPS, for side viewing of a wafer from all angles using an optical lens that is sat on a carriage and a circular rail

FIG. 4 shows a typical X,Y,Z micromanipulator that is sat on a carriage that enables the movement of an optical lens

FIG. 5 shows a typical motorized X,Y,Z stage with other parts for holding and tilting the wafers

FIG. 6 shows a wafer holders that hold the silver coated wafer as well as the gallium film or array

FIG. 7 shows an apparatus for moving 2 lenses individually in X and Y direction

FIG. 8 shows a method for making uniform liquid metal film and patterning liquid metal film

### DETAILED DESCRIPTION OF THE PREFERRED EMBODIMENTS

The present invention, in one embodiment, enables a novel non-device fabrication capability that can be adopted by the microelectronics industry. Nanoneedles Pulling Station (NPS) impacts a much broader set of technologies. NPS provides the capability to scientist to grow high aspect ratio nanostructures onto micro structures. Using embodiments of the present invention, many novel nanostructure based devices are fabricated for various applications and a much broader class of Nanoelectromechanical Systems (NEMS) could be produced very cost effectively. Since the Nanoneedles arrays are fabricated with high throughput, it is expected to be adopted by micro/nanoelectronic industry for integrating nanostructures into electronic circuits.

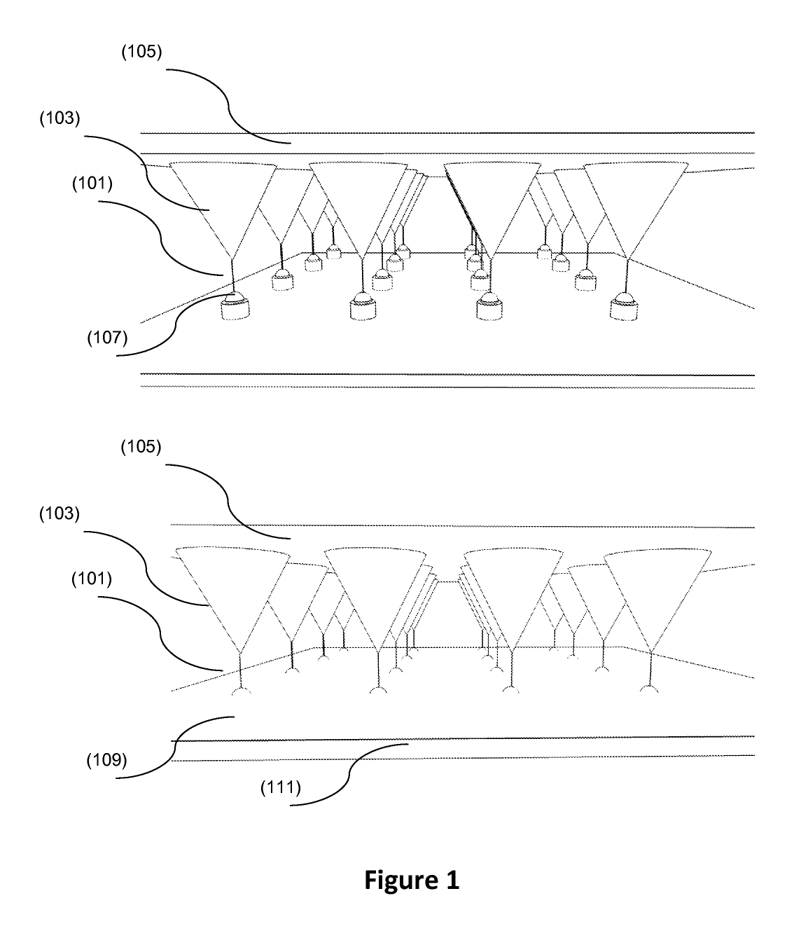

As shown in FIG. 1A-E, based on this embodiment, an instrument is developed that is capable of selectively forming nanoneedles array (101) by bringing a pattern of silver pads (103) that are made by standard optical photolithography on a silicon wafer (105) in contact with an array of gallium droplets (107) or a film of gallium (109) that are formed on a substrate (111). The nanoneedles array (101) is formed based on the interaction of gallium droplets (107) or array (109) with silver at room temperature in ambient conditions.

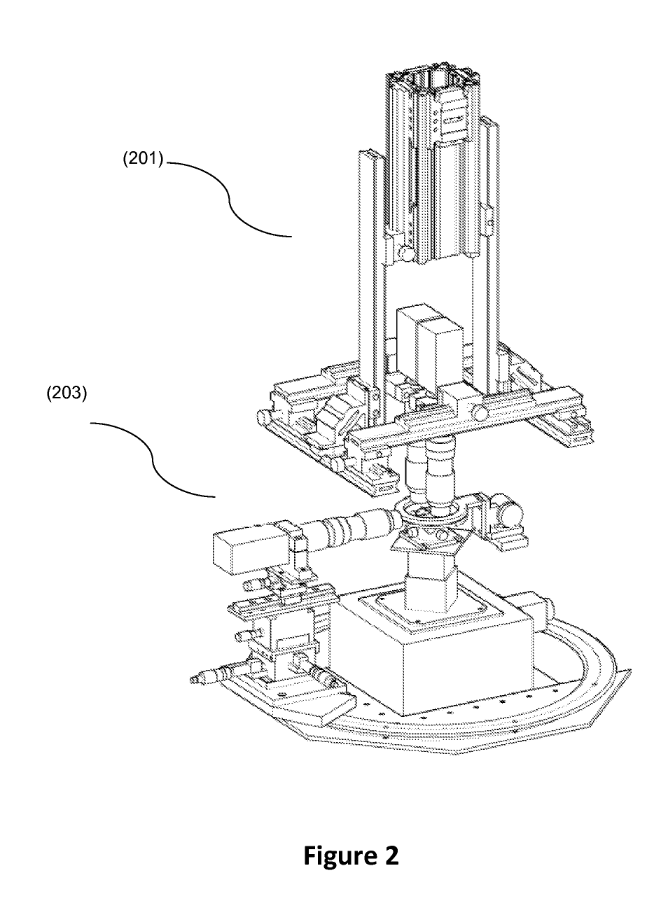

FIG. 2 shows the overall embodiment of the NPS instrument. The NPS capable of aligning two wafers laterally in X and Y direction as well as making them in parallel with respect to each other. The NPS is capable of bringing in contact the two wafers with sub 100 nm resolution and pull the two surface away from each other either in vertical direction or in a desired angle. In summary the NPS is made of two main section, Upper assembly (201) and lower assembly (203). The detail components of each section of the NPS instrument are explained in the following Figures.

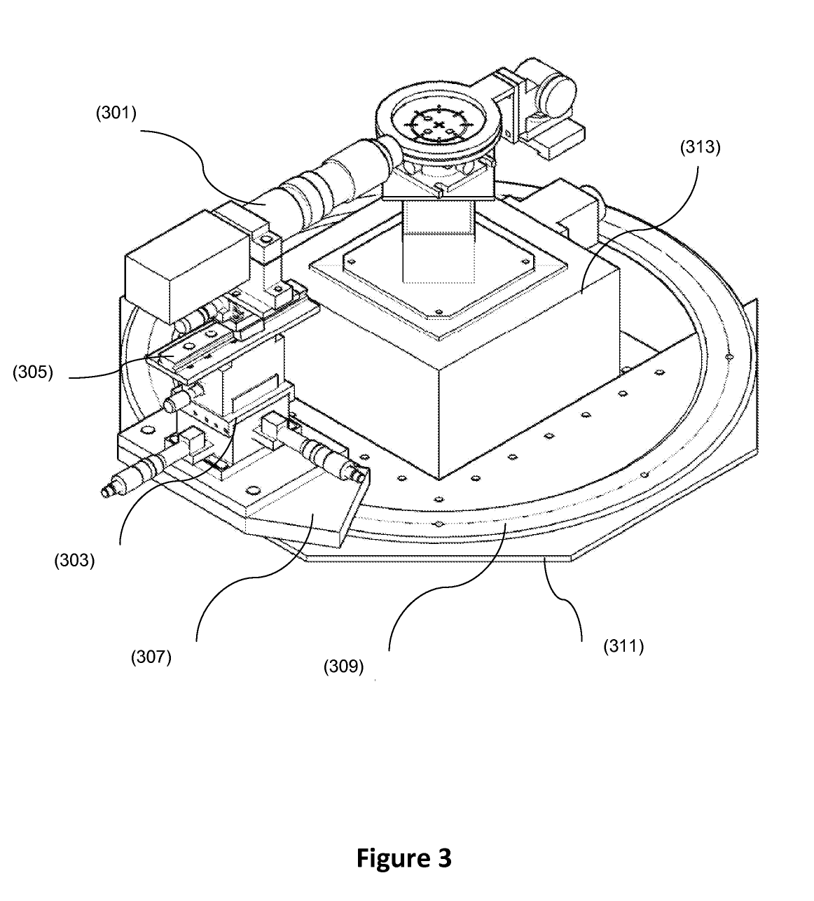

FIG. 3 shows an embodiment of the novel apparatus of the lower assembly (201) of the NPS. The lower assembly (201) is to make the two substrates parallel with each other before bringing the two wafers in contract. A side view optical lens (301) is viewing the gap between the two wafers during the approach. The optical lens is sat on a X,Y,Z micromanipulators (303) and a rail (305) that is capable of fine movement the optical lens. The X,Y,Z micromanipulator is sat on a carriage (307) which is on a circular rail (309). The circular rail is sat on a plate (311). In the middle of circular rail (309) there is a motorized micromanipulator (313) that is for moving the lower wafer in X,Y,Z direction. More detail of the lower assembly (201) section is explained in the following.

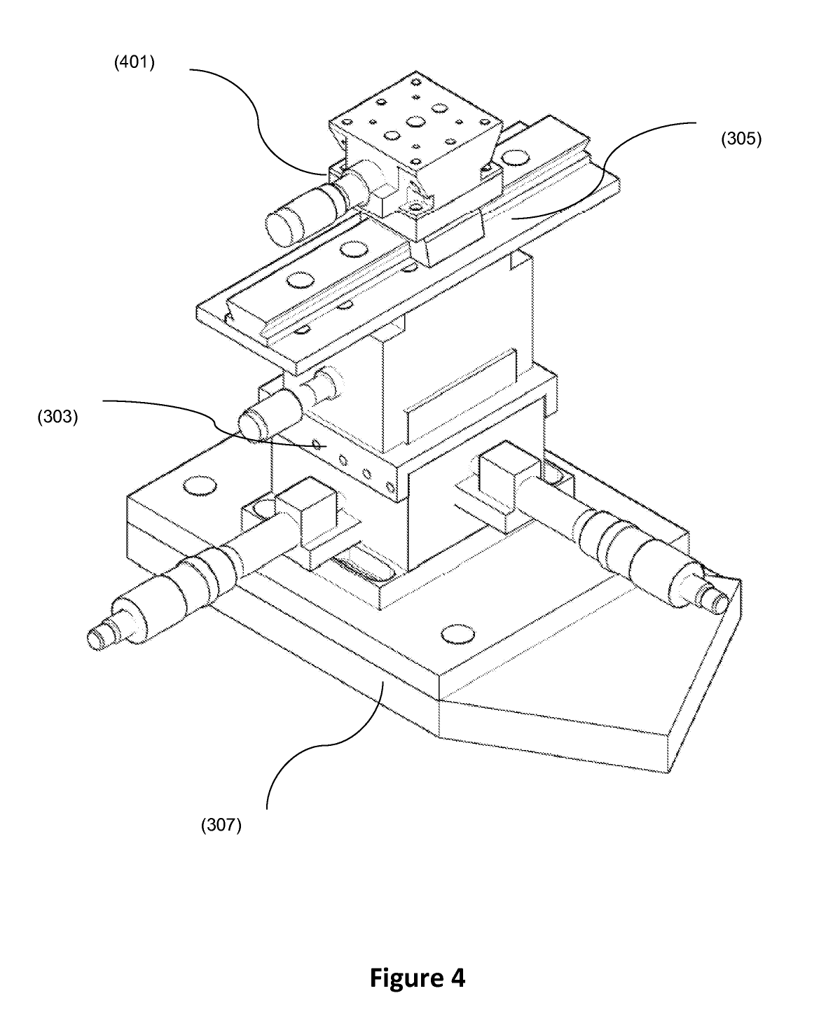

FIG. 4 shows an embodiment of the present invention for the apparatus of the manipulation and movement for the side view lens (301). Under the lens (301) there is a tilt state (401) that enables the tilt the lens within 5 degree.

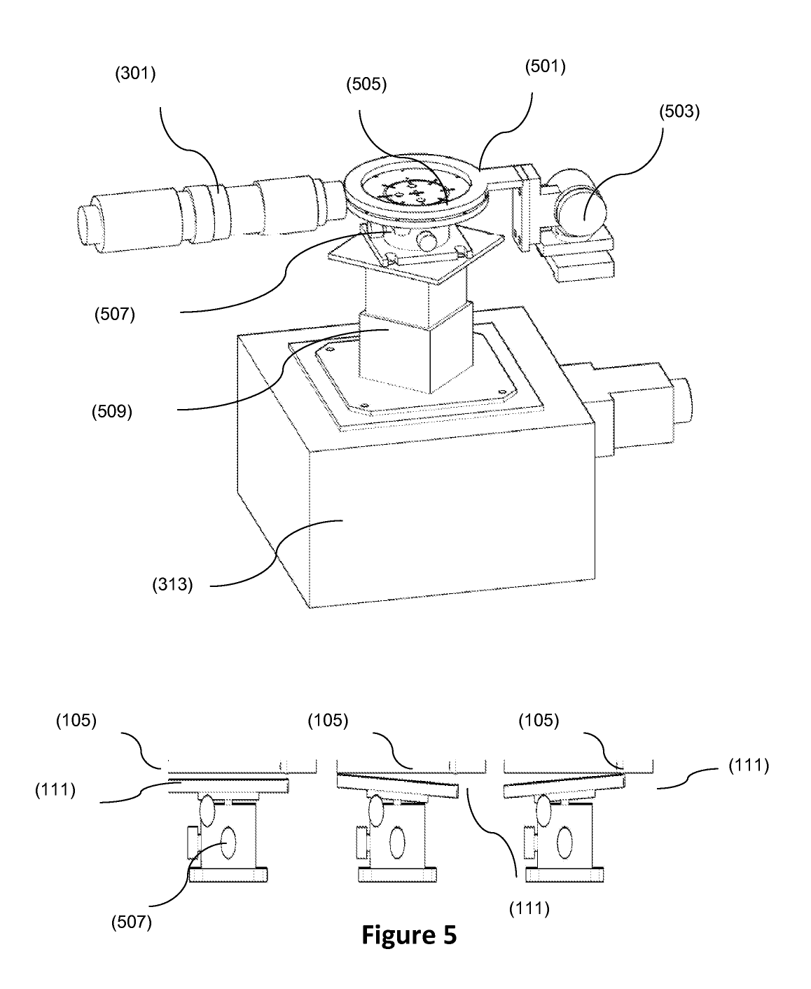

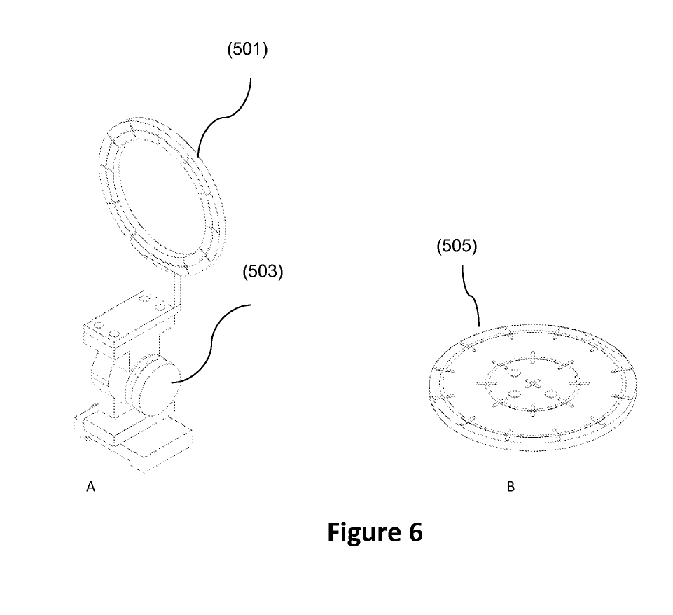

FIG. 5 shows the parts that are sat on the motorized manipulators (311) in the middle of the lower assembly (203). A ring shape vacuum chuck (501) is designed to hold the silicon wafer that is coated with silver (105). The ring (501) is connected to a hinge (503) in order to change the angle of the ring (501) between 0 to 90 degrees. See FIG. 6 for details. Under the ring (501), there is a disk shape vacuum chuck (505) that holds the gallium substrate (111). The disk (505) is sat on a tilt and rotation stage (507) that can tilt the disk shape wafer holder (505). FIG. 5B shows the tilt state (507) has been used to align the silver substrate (105) with gallium substrate (111). Between the motorized manipulator (311) and the tilt stage (507), there is a typical metal stand (509) to increase the height of the tilt stage (507) and therefore the gallium substrate (111) to be viewed by optical lens (301).

FIG. 6A-B shows the close up view of the Wafer holders (501) and (505). As shown in FIG. 6A the hinge is designed to change the angle of the ring shape wafer holder (501) between 0 to 90 degrees.

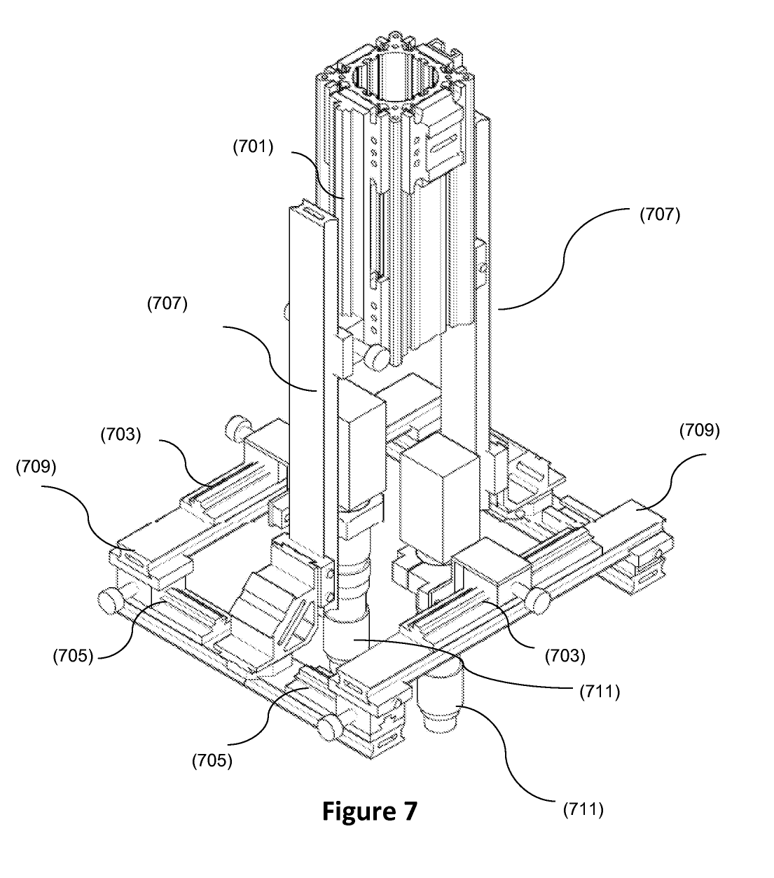

FIG. 7 shows the upper assembly (201). The upper assembly is designed to enable the movement of the two optical lenses (711) independently with high Precision. As a part of the upper assembly (201), there are two vertical rails (701) that are to move the two optical lenses in vertical direction. There are also four more rails, two in X direction (703) and two are in the Y direction (705) that enable the optical lenses to move in the X and Y direction independently. The rails (701) to (705) are supported by metal supports (707) and (709).

Method for Liquid Metal Patterning

In another embodiment, the present invention teaches a novel method for pattering liquid metal such as gallium. The following are methods in patterning the gallium over large flat substrates, over micropillar arrays, and over recesses etched or photopatterned into silicon or glass substrates (with appropriate thin film coatings added for adhesion).

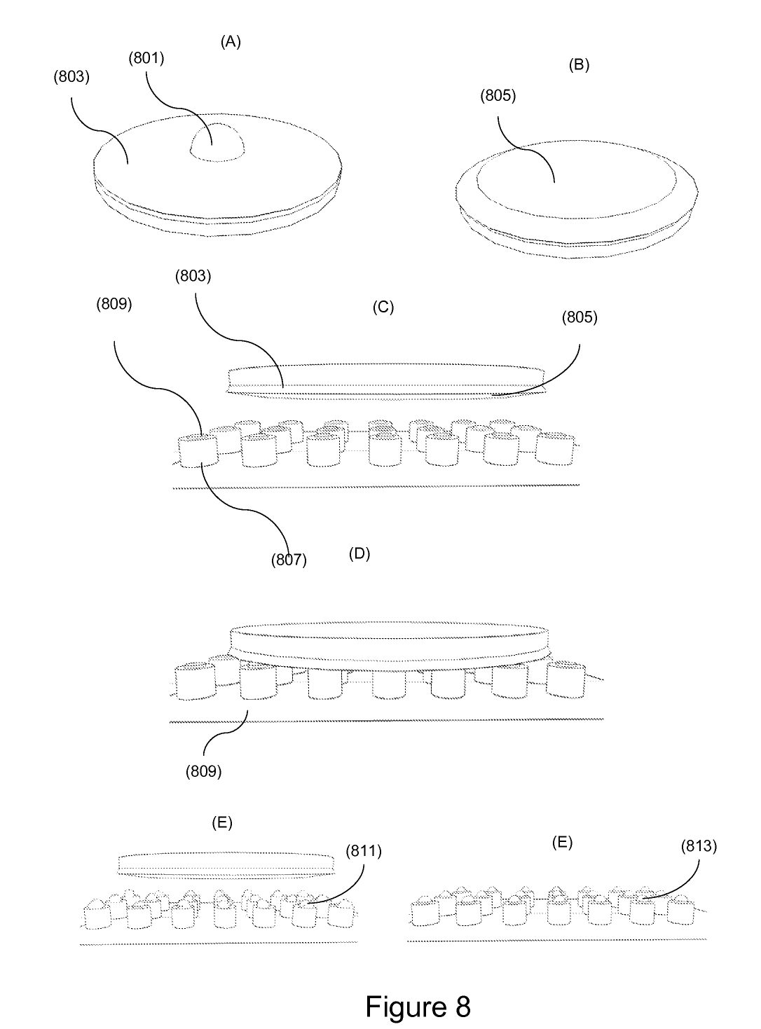

As shown in FIG. 8A-F, a smooth gallium film (805) would be formed by stretching an elastic membrane (803). The Gallium droplet (801) is first deposited on a flexible stretchable membrane (803). The membrane (803) then is then stretched to flatten the gallium film and form a uniform gallium film (805). As shown in FIG. 8C, the gallium film (805) is then brought in contact with and later pressed against (FIG. 8D) a pillar array (807) to transfer and pattern the gallium. By coating the tip of the pillars with a thin adhesive layer (809) (the selected metal or metal oxide as determined from the wetting studies above), it is anticipated to pattern gallium droplets onto pillars (or patterned metal/metal oxide surface) with high uniformity.

As shown in FIG. 8E, the gallium droplets with irregular shapes (811) are transferred onto the top of pillar array (807). Uniform and more rounded gallium droplets (813) are formed after etching gallium droplets with dilute acid such as hydrochloric acid (HCl) or hydrofluoric acid (HF) or similar. Either the edges of the pillars or smaller patterned patches of the adhesive layer on top of a pillar can be used to control the shape of the droplet through pinning of the contact line. For example, a patch of adhesion coating with a circular shape would produce a hemispherical gallium droplet (FIG. 6d), while a square patch would produce a square pillow-shaped droplet. Flexible gallium-coated membranes (803) can directly contact and conform to an entire array of silver-coated substrate with high uniformity.

From this technique, very high throughput (>95%) are obtained and majority of pillars had small spherical droplets of gallium perfectly covering their tops (the spherical droplets with diameters equal to the diameter of pillars) without any gallium squeezing in between the pillars. Note that the etching time in HCl is very important parameters and prolonged etchings of even 1-2 seconds longer than optimum duration may result in dissolution entire gallium. Note that due to removal of oxide layers gallium droplets tend to take round-sphere shapes meaning that their surface tension is increased.

One embodiment of present invention, teaches an apparatus for providing micromanipulation capability for growing nanostructures array (101). This apparatus comprises of the following elements:

a first motorized micromanipulator (313) for moving a first substrate (111) having a first set of features (107),

a first mechanism mounted on a second platform to hold a second substrate (105) having a second set of features (103) over the first substrate (111),

a second mechanism (507) mounted on the motorized micromanipulator (313) to change tilts of any of the substrates (111) so that the substrates become parallel with a second substrate (105), and

one or more top-view lenses (711).

In this embodiment, the first substrate (105) hovers below the second substrate (111) by the first mechanism (313), the first micromanipulator aligns the first set of features (107) on the first substrate (111) with the second set of features (103) on the second substrate (105), and the second mechanism (507) ensures that the substrates are positioned in parallel.

In one embodiment the present invention comprises one or more side-view lenses (301) mounted on a second micromanipulator (303) installed on a carrier (307) on a rail (309) affixed to the first platform (311). In another embodiment, the first mechanism (313) holds the second substrate (105) using a circular vacuum chuck (505). In anther embodiment, a second platform hold the ring shape vacuum chuck (501) wherein the ring shape vacuum chuck is connected to a hinge (503) and the hinge is mounted on the second platform. In yet another embodiment, the first set of features (103) are made of one or more metals selected from the group consisting of silver, platinum, gold, aluminum, copper, cobalt, iron, palladium, rhodium, ruthenium, iridium, and osmium. In one embodiment, the second set of features (107) and (109) are made of gallium.

In one embodiment, the first mechanism (313) is capable of changing the distance between the second substrate (105) and the first substrate (111). In another embodiment, the apparatus is capable of in-situ growth of nanowires (101) by first reducing the distance between the substrates (111) and (105), and as a result, bringing into contact some of the second features on the second substrate (111) with some of the first features on the first substrate (105) using the first mechanism (313) and subsequently increasing the distance between the substrates to grow nanowires (101).

A further embodiment of the present invention teaches a method for growing nanostructures comprising the steps of:

forming a first set of features on a first substrate (105),

forming a second set of features on a second substrate (111),

bringing into proximity the first set of features (103) on the first substrate (105) with second set of features (107) on the second substrate (111) such that some elements of the first set of features (103) touch some elements of the second set of features (107) on second substrate (111), and

pulling gently apart the two substrates to grow nanostructures (101).

In one embodiment, the nanostructures are nanowires and in another embodiment, the first set of features (103) are made of one or more metals selected from the group consisting of silver, platinum, gold, aluminum, copper, cobalt, iron, palladium, rhodium, ruthenium, iridium, and osmium.

In one embodiment, the second set of features (107) are made of gallium.

A further embodiment of the present invention teaches a method for liquid metal patterning. The method comprises of the steps of:

transferring a liquid metal mass to an elastic membrane (803),

stretching the membrane (803) so that a smooth film (805) of the liquid metal mass (801) is formed on the membrane (803),

pressing the membrane against a target surface (811) to transfer the metal droplets (811) of the liquid metal (801) mass on the membrane (803) to the target surface (811)

In one embodiment, the target surface (811) is a micro-pillar's tip (807) and the micro-pillar's tip is coated with a thin adhesive layer (809) prior to transferring the liquid droplet (813). In another embodiment, the thin adhesive layer's shape (809) is modified to achieve desired shape of the liquid metal mass (815).

In one embodiment, the thin adhesive layer (809) is made of one or more metal or metal oxide, selected based on desired wetting properties.

In a further embodiment of the present invention, after transferring the liquid metal (805) to the elastic membrane (803), the liquid droplets (813) are treated with dilute hydrochloric acid to remove irregularities in the shape of the surface of the transferred liquid metal and make uniform droplets (815).

We point out that descriptions of application-specific details such as starting materials, components, assembly techniques and other well known details are summarized or omitted merely so as not to unnecessarily obscure the details of the present invention and to improve clarity. Thus it is possible that details as presented in this embodiment of the invention are otherwise well known for some particular embodiments of this or similar inventions, and we let the application of the present invention to suggest or dictate choices concerning those details.

Any variations of the above teachings are also intended to be covered by this patent application.

1. An apparatus for providing micromanipulation capability for growing nanostructures, said apparatus comprising;
a first micromanipulator mounted on a first platform for moving a first substrate having a first set of features,
a first mechanism mounted on a second platform to hold a second substrate having a second set of features over said first substrate,
a second mechanism mounted on said first platform to change tilts of any of said substrates so that said substrates become parallel, and
one or more top-view lenses,
wherein said second substrate hovers above said first substrate by said first mechanism, said first micromanipulator aligns said first set of features on said first substrate with said second set of features on said second substrate, and said second mechanism ensures that said substrates are positioned in parallel.

2. The apparatus of claim 1 further comprising one or more side-view lenses mounted on a second micromanipulator installed on a carrier on a rail affixed to said first platform.

3. The apparatus of claim 1 wherein said first mechanism holds said second substrate using a circular vacuum chuck, wherein said circular vacuum chuck is connected to a hinge and said hinge is mounted on said second platform.

4. The apparatus of claim 1, wherein said first set of features are made of one or more metals selected from the group consisting of silver, platinum, gold, aluminum, copper, cobalt, iron, palladium, rhodium, ruthenium, iridium, and osmium.

5. The apparatus of claim 1, wherein said second set of features are made of gallium.

6. The apparatus of claim 1, wherein said second mechanism is capable of changing the distance between said second substrate and said first substrate.

7. The apparatus of claim 6 further capable of in-situ growth of nanowires by first reducing the distance between said substrates, and as a result, bringing into contact some of said second features on said second substrate with some of said first features on said first substrate using said first mechanism and subsequently increasing the distance between said substrates to grow nanowires.

8. A method for growing nanostructures comprising the steps of,
forming a first set of features on a first substrate,
forming a second set of features on a second substrate,
bringing into proximity said first set of features on said first substrate with second set of features on said second substrate such that some elements of said first set of features touch some elements of said second set of features on second substrate, and
pulling gently apart said two substrates to grow nanostructures.

9. The method of claim 8, wherein said substrates are made of silicon.

10. The method of claim 8, wherein said nanostructures are nanowires.

11. The method of claim 8, wherein said first set of features are made of one or more metals selected from the group consisting of silver, platinum, gold, aluminum, copper, cobalt, iron, palladium, rhodium, ruthenium, iridium, and osmium.

12. The method of claim 8, wherein said second set of features are made of gallium.

13. A method for liquid metal patterning, said method comprising the steps of:
transferring a liquid metal mass to an elastic membrane,
stretching said membrane so that a smooth film of said liquid metal mass is formed on said membrane,
pressing said membrane against a target surface to transfer said smooth film of said liquid metal mass on said membrane to said target surface

14. The method of claim 13 wherein said target surface is a micro-pillar's tip and said micro-pillar's tip is coated with a thin adhesive layer prior to transferring said smooth film of said liquid metal mass.

15. The method of claim 14 wherein said thin adhesive layer's shape is modified to achieve desired shape of said liquid metal mass.

16. The method of claim 14 wherein said thin adhesive layer is made of one or more metal or metal oxide, selected based on desired wetting properties.

17. The method of claim 13 wherein after transferring said liquid metal to said elastic membrane, said liquid metal is treated with dilute hydrochloric acid to remove irregularities in the shape of the surface of said transferred liquid metal.
